(19) United States
(12) Patent Application Publication
(10) Pub. No.: US 2003/0199268 A1
(43) Pub. Date: Oct. 23, 2003

(54) System, server, method, and computer program for delivering sound data

(75) Inventor: Masataka Abe, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/413,208

(22) Filed: Apr. 15, 2003

(30) Foreign Application Priority Data
Apr. 17, 2002 (JP) 115131/2002

(51) Int. Cl. H04M 3/00

(52) U.S. Cl. 455/419; 455/418

(57) ABSTRACT

A system for delivering sound data, in which a user can select sound data freely as sound data using in his/her own user terminal via a network after the user purchased the user terminal, in particular, in which the payment burden for the user to register the sound data is made reasonable, is provided. When a server for delivering sound data received a request from a user terminal to deliver some sound data, the server for delivering sound data judges whether the terminal ID of the user terminal has been registered in a user terminal management database, and also confirms whether the remaining number of sound data to be delivered to the user terminal is “0” or not. When the remaining number was not “0”, the server for delivering sound data transmits information to select the sound data. When the user selected the sound data, the server for delivering sound data transmits the sound data to the user terminal without a charge under the price condition of the user terminal. The user terminal registers the received sound data in the user terminal. With this operation, the user can obtain his/her desiring sound data freely.

### BACKGROUND OF THE INVENTION

The present invention relates to a system, a server, a method and a computer program for delivering sound data, in which a user can select sound data freely as sound data using in his/her own user terminal via a network after the user purchased the user terminal. In this, the computer program works to deliver the sound data from the server for delivering sound data to the user terminals via the network.

Description of the Related Art

Conventionally, a user terminal such as a mobile communication terminal having a function generating some music as a ringing tone has been widely used, when the user terminal received a phone call or an e-mail. The music, which is generated at the time when the phone call was received at the user terminal, is generally called as a ringing tone melody. Recently, several ringing tone melodies have been already registered in most of the user terminals such as the mobile communication terminals at the time when the user terminals are sold. That is, when a user purchased a user terminal, several ringing tone melodies have been already registered in the user terminal.

Hereinafter, the ringing tone melodies, which have been stored in a memory of the user terminal and are sold with the user terminal, are referred to as built-in ringing tone melodies. The ringing tone melodies are selected by the manufacturer of the user terminal and are stored in the user terminal before the user terminal is sold.

However, the built-in ringing tone melodies have not been selected by the user, who purchased the user terminal, therefore the melodies do not always suit the taste of the user. Therefore, in many cases, the built-in ringing tone melodies are not used effectively.

In the built-in ringing tone melodies, there are some melodies that need to pay royalties to copyright holders such as composers and singers. Therefore, the price of the user terminal includes the amount of money corresponding to the royalties. Consequently, a burden to pay the royalties is imposed on even a user who does not use the built-in ringing tone melodies. Therefore, the user, who purchased the user terminal, is obliged to pay an unwanted expense, because the user must pay the royalties of the not using built-in ringing tone melodies.

In case that a melody, which suits his/her taste, does not exist in the built-in ringing tone melodies, it is possible that the user obtains a desiring ringing tone melody from a web site that offers ringing tone melodies. However, in this case, the user must pay an expense for obtaining the ringing tone melody, in addition to the expense that was paid at the time when the user purchased the user terminal including the royalties of the built-in ringing tone melodies.

Therefore, when a desiring melody does not exist in the built-in ringing tone melodies, the user can obtain his/her desiring melody from a web site. However, in case that the expense of the user is compared with that of a user who likes all of the built-in ringing tone melodies, the user who obtained his/her desiring melody from the web site must pay additional expense.

Moreover, the built-in ringing tone melodies have been registered in the user terminal before it is sold. Therefore, for example, it is impossible that a latest melody, which was released after the user had purchased the user terminal, is made one of the built-in ringing tone melodies.

Furthermore, when a ringing tone voice, which is not a melody but a voice of a person or an animal, or some music that is not generally used as the ringing tone, has been registered in the user terminal before the user terminal is sold, the situation is the same as mentioned above. That is, in this case, the user must obtain a desiring ringing tone melody by paying an additional expense.

### SUMMARY OF THE INVENTION

It is therefore an object of the present invention to provide a system, a server, a method and a computer program for delivering sound data, in which a user can select sound data freely as sound data using in his/her own user terminal via a network after the user purchased the user terminal, in particular, in which the payment burden for the user for registering the sound data is made reasonable and the user can register some latest sound data as the ringing tone.

According to a first aspect of the present invention, for achieving the object mentioned above, there is provided a system for delivering sound data, which provides plural user terminals and a server for delivering sound data that delivers sound data to each of the plural user terminals via a network as sound data of each of the plural user terminals, and in which each of the plural user terminals obtains the sound data from the server for delivering sound data via the network and registers the obtained sound data as its own sound data. And the server for delivering sound data provides a judging information storing means, in which the information of remaining quantity of sound data to be delivered to each of the plural user terminals, showing the quantity of the sound data that each of the plural user terminals can obtain, is stored, and a sound data storing means in which the sound data to be delivered to each of the plural user terminals are stored. And in case that each of the plural user terminals requests the server for delivering sound data to deliver some sound data via the network, the server for delivering sound data delivers the sound data storing in the sound data storing means to each of the plural user terminals within the range of the information of remaining quantity of sound data to be delivered to each of the plural user terminals storing in the judging information storing means via the network, without a charge under the price condition of each of the plural user terminals.

According to a second aspect of the present invention, in the first aspect, the judging information storing means stores the terminal IDs of the plural user terminals for identifying each of the plural user terminals, and the information of remaining quantity of sound data to be delivered to each of the plural user terminals is stored corresponding to each of the terminal IDs, and the information of remaining quantity of sound data is the information of remaining number of sound data to be delivered to each of the plural user terminals, and the remaining number of sound data is the number that the already delivered number of sound data to each of the plural user terminals is subtracted from the predetermined initial number of sound data that can be delivered to each of the plural user terminals. And in case that the server for delivering sound data receives a request to deliver some sound data from each of the plural user terminals, the server for delivering sound data delivers the sound data storing in the sound data storing means to each of the plural user terminals within the range of the information of remaining number of sound data to be delivered to each of the plural user terminals storing in the judging information storing means via the network, without a charge under the price condition of each of the plural user terminals.

According to a third aspect of the present invention, in the first aspect, the judging information storing means stores the terminal IDs of the plural user terminals for identifying each of the plural user terminals, and the information of remaining quantity of sound data to be delivered to each of the plural user terminals is stored corresponding to each of the terminal IDs, and the information of remaining quantity of sound data is the information of remaining amount of royalties for sound data to each of the plural user terminals, and the remaining amount of royalties is the amount that the amount of royalties for already delivered sound data to each of the plural user terminals is subtracted from the predetermined initial amount of royalties that each of the plural user terminals can use for obtaining the sound data. And in case that the server for delivering sound data receives a request to deliver some sound data from each of the plural user terminals, the server for delivering sound data delivers the sound data storing in the sound data storing means to each of the plural user terminals within the range of the information of remaining amount of royalties for each of the plural user terminals storing in the judging information storing means via the network, without a charge under the price condition of each of the plural user terminals.

According to a fourth aspect of the present invention, in the first aspect, the server for delivering sound data further provides a delivered information storing means, in which the information of the delivered accumulation number of sound data in each title of the sound data is stored. And the server for delivering sound data accumulates the number of the delivered sound data in each title of the sound data and stores the delivered accumulation number in each title in the delivered information storing means, and when royalties for each title of the sound data are paid to the copyright holder of each title, the information of the delivered accumulation number storing in the delivered information storing means is used.

According to a fifth aspect of the present invention, in the first aspect, each of the plural user terminals is a mobile communication terminal having a radio communication function.

According to a sixth aspect of the present invention, in the first aspect, each of the plural user terminals is a PC (personal computer) connecting to the Internet telephony or some PDA (personal digital assistants) that receives a phone call or an e-mail.

According to a seventh aspect of the present invention, in the first aspect, the sound data are sound source data of ringing tone melodies showing music that is used as a ringing tone at the time when each of the plural user terminals received a phone call or an e-mail.

According to an eighth aspect of the present invention, in the first aspect, the sound data are sound source data of ringing tone voices using as a ringing tone at the time when each of the plural user terminals received a phone call or an e-mail.

According to a ninth aspect of the present invention, for achieving the object mentioned above, there is provided a server for delivering sound data, which delivers sound data to each of plural user terminals as its own sound data that is registered in each of the plural user terminals via a network. The server for delivering sound data provides a judging information storing means, in which the information of remaining quantity of sound data to be delivered to each of the plural user terminals, showing the quantity of the sound data that each of the plural user terminals can obtain, is stored, and a sound data storing means in which the sound data to be delivered to each of the plural user terminals are stored. And in case that each of the plural user terminals requests the server for delivering sound data to deliver some sound data via the network, the server for delivering sound data delivers the sound data storing in the sound data storing means to each of the plural user terminals within the range of the information of remaining quantity of sound data to be delivered to each of the plural user terminals storing in the judging information storing means via the network, without a charge under the price condition of each of the plural user terminals.

According to a tenth aspect of the present invention, in the ninth aspect, the judging information storing means stores the terminal IDs of the plural user terminals for identifying each of the plural user terminals, and the information of remaining quantity to be delivered to each of the plural user terminals is stored corresponding to each of the terminal IDs.

According to an eleventh aspect of the present invention, in the tenth aspect, the information of remaining quantity to be delivered to each of the plural user terminals is the information of remaining number of sound data to be delivered to each of the plural user terminals, being the information of the remaining number of sound data that each of the plural user terminals can obtain.

According to a twelfth aspect of the present invention, in the eleventh aspect, in case that the server for delivering sound data receives a request to deliver some sound data from each of the plural user terminals, the server for delivering sound data delivers the sound data storing in the sound data storing means to each of the plural user terminals within the range of the information of remaining number of sound data to be delivered to each of the plural user terminals storing in the judging information storing means with each of the terminal IDs via the network, without a charge under the price condition of each of the plural user terminals.

According to a thirteenth aspect of the present invention, in the twelfth aspect, in case that the server for delivering sound data delivered some sound data to each of the plural user terminals by receiving a request to deliver some sound data from each of the plural user terminals, the server for delivering sound data renews the remaining number of sound data in the judging information storing means by subtracting the delivered number of sound data from the remaining number.

According to a fourteenth aspect of the present invention, in the tenth aspect, the information of remaining quantity to be delivered to each of the plural user terminals is the information of remaining amount of royalties for sound data to each of the plural user terminals, being the information of remaining amount of royalties for sound data that each of the plural user terminals can obtain some sound data by using the remaining amount of royalties.

According to a fifteenth aspect of the present invention, in the fourteenth aspect, in case that the server for delivering sound data receives a request to deliver some sound data from each of the plural user terminals, the server for delivering sound data delivers the sound data storing in the sound data storing means to each of the plural user terminals within the range of the information of remaining amount of royalties for sound data to each of the plural user terminals storing in the judging information storing means with each of the terminal IDs via the network, without a charge under the price condition of each of the plural user terminals.

According to a sixteenth aspect of the present invention, in the fifteenth aspect, in case that the server for delivering sound data delivered some sound data to each of the plural user terminals by receiving a request to deliver some sound data from each of the plural user terminals, the server for delivering sound data renews the remaining amount of royalties for sound data storing in the judging information storing means by subtracting the amount of royalties for the delivered sound data from the remaining amount.

According to a seventeenth aspect of the present invention, in the ninth aspect, the server for delivering sound data further provides a delivered information storing means, in which the information of the delivered accumulation number of sound data in each title of the sound data is stored. And the server for delivering sound data accumulates the number of the delivered sound data in each title of the sound data and stores the delivered accumulation number in each title in the delivered information storing means, and when royalties for each title of the sound data are paid to the copyright holder of each title, the information of the delivered accumulation number storing in the delivered information storing means is used.

According to an eighteenth aspect of the present invention, in the ninth aspect, the sound data are sound source data of ringing tone melodies showing music that is used as a ringing tone at the time when each of the plural user terminals received a phone call or an e-mail.

According to a nineteenth aspect of the present invention, in the ninth aspect, the sound data are sound source data of ringing tone voices using as a ringing tone at the time when each of the plural user terminals received a phone call or an e-mail.

According to a twentieth aspect of the present invention, for achieving the object mentioned above, there is a method for delivering sound data, in which sound data are delivered to each of plural user terminals via a network as its own sound data that is registered in each of the plural user terminals. The method for delivering sound data provides the steps of, receiving a request for obtaining sound data from each of the plural user terminals via the network, judging whether the sound data are delivered to each of the plural user terminals via the network or not, based on the information of remaining number of sound data to be delivered to each of the plural user terminals, when the request was received, delivering the sound data to each of the plural user terminals within the range of the information of remaining number of sound data to be delivered without a charge under the price condition of each of the plural user terminals, when it was judged to deliver the sound data, subtracting the delivered number of sound data from the remaining number of sound data in each of the plural user terminals, and adding the delivered number of sound data to the delivered accumulation number of sound data in each title of the sound data.

According to a twenty-first aspect of the present invention, for achieving the object mentioned, there is provided a method for delivering sound data, in which sound data are delivered to each of plural user terminals via a network as its own sound data that is registered in each of the plural user terminals. The method for delivering sound data provides the steps of receiving a request for obtaining sound data from each of the plural user terminals via the network, judging whether the sound data are delivered to each of the plural user terminals via the network or not, based on the information of remaining amount of royalties for sound data to be delivered to each of the plural user terminals, when the request was received, delivering the sound data to each of the plural user terminals within the range of the information of remaining amount of royalties for sound data without a charge under the price condition of each of the plural user terminals, when it was judged to deliver the sound data, subtracting the amount of royalties of the delivered sound data from the remaining amount of royalties in each of the plural user terminals, and adding the delivered number of sound data to the delivered accumulation number of sound data in each title of the sound data.

According to a twenty-second aspect of the present invention, in the twentieth aspect, the information of remaining number of sound data is stored corresponding to each of the terminal IDs of the plural user terminals.

According to a twenty-third aspect of the present invention, in the twenty-first aspect, the information of remaining amount of royalties for sound data is stored corresponding to each of the terminal IDs of the plural user terminals.

According to a twenty-fourth aspect of the present invention, for achieving the object mentioned above, there is provided a computer program for delivering sound data, in which sound data are delivered to each of plural user terminals via a network as its own sound data that is registered in each of the plural user terminals. The computer program for delivering sound data provides a receiving step for receiving a request for obtaining sound data from each of the plural user terminals via the network, a judging step for judging whether the sound data are delivered to each of the plural user terminals via the network or not, based on the information of remaining number of sound data to be delivered to each of the plural user terminals, when the request was received, a delivering step for delivering the sound data to each of the plural user terminals within the range of the information of remaining number of sound data to be delivered without a charge under the price condition of each of the plural user terminals, when it was judged to deliver the sound data, a subtracting step for subtracting the delivered number of sound data from the remaining number of sound data in each of the plural user terminals, and an adding step for adding the delivered number of sound data to the delivered accumulation number of sound data in each title of the sound data.

According to a twenty-fifth aspect of the present invention, for achieving the object mentioned above, there is provided a computer program for delivering sound data, in which sound data are delivered to each of plural user terminals via a network as its own sound data that is registered in each of the plural user terminals. The computer program for delivering sound data provides a receiving step for receiving a request for obtaining sound data from each of the plural user terminals via the network, a judging step for judging whether the sound data are delivered to each of the plural user terminals via the network or not, based on the information of remaining amount of royalties for sound data to be delivered to each of the plural user terminals, when the request was received, a delivering step for delivering the sound data to each of the plural user terminals within the range of the information of remaining amount of royalties for sound data without a charge under the price condition of each of the plural user terminals, when it was judged to deliver the sound data, a subtracting step for subtracting the amount of royalties of the delivered sound data from the remaining amount of royalties in each of the plural user terminals, and an adding step for adding the delivered number of sound data to the delivered accumulation number of sound data in each title of the sound data.

According to a twenty-sixth aspect of the present invention, in the twenty-fourth aspect, the information of remaining number of sound data is stored corresponding to each of the terminal IDs of the plural user terminals.

According to a twenty-seventh aspect of the present invention, in the twenty-fifth aspect, the information of remaining amount of royalties for sound data is stored corresponding to each of the terminal IDs of the plural user terminals.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of a system for delivering sound data at embodiments of the present invention;

FIG. 2 is a diagram showing an example of a data storing state in a user terminal management database at a first embodiment of the present invention;

FIG. 3 is a diagram showing an example of a data storing state in a sound data management database at the embodiments of the present invention;

FIG. 4 is a diagram showing an example of a data storing state in a delivered information management database at the embodiments of the present invention; and

FIG. 5 is a flowchart showing ringing tone melody delivering processes and their process timing at the system for delivering sound data at the first embodiment of the present invention.

### DESCRIPTION OF THE PREFERRED EMBODIMENTS

Referring now to the drawings, embodiments of the present invention are explained in detail.

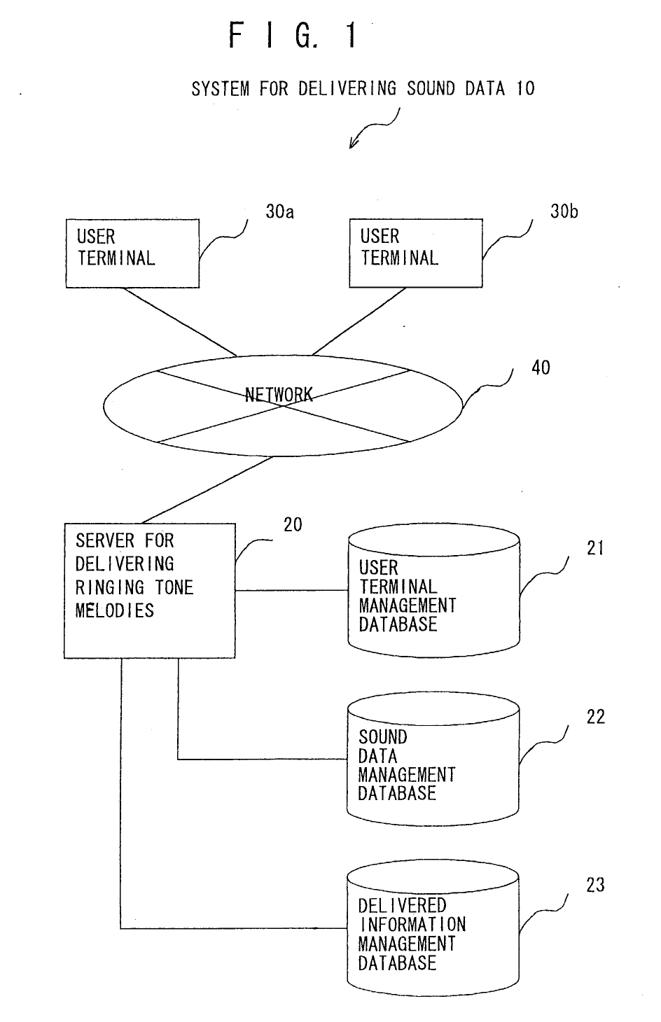

FIG. 1 is a block diagram showing a structure of a system for delivering sound data at the embodiments of the present invention. As shown in FIG. 1, the system for delivering the sound data 10 consists of a server for delivering ringing tone melodies 20 (server for delivering sound data), a user terminals 30a and 30b, and a network 40. The server for delivering ringing tone melodies 20 is connected to the network 40 such as the Internet. The user terminals 30a and 30b are connected to the network 40 via a radio or wire communication network. In this, the number of the user terminals is not limited to two, and actually plural user terminals are connected to the network 40. And the server is named as the server for delivering ringing tone melodies, however, the server can deliver any form of sound data.

At the system for delivering sound data 10 in the embodiments of the present invention, built-in ringing tone melodies, which have been conventionally registered in the user terminal before the user terminal is sold to a user, are not registered in the user terminals 30a and 30b. And the ringing tone melodies are registered in the user terminals 30a and 30b, by receiving from the server for delivering ringing tone melodies 20 via the network 40 after the user terminals 30a and 30b were sold. In this case, the price of each of the user terminals 30a and 30b includes the price of the ringing tone melodies, which are registered after purchased. That is, for example, the price of each of the user terminals 30a and 30b is equal to that of a user terminal in which some ringing tone melodies have been already registered.

The server for delivering ringing tone melodies 20 is an information processing apparatus such as a server connecting to the Internet, and is managed by a ringing tone melody delivering company that delivers the ringing tone melodies, which become the ringing tone melodies in the user terminals 30a and 30b. The server for delivering ringing tone melodies 20 has a function as a WWW (world wide web) server, and also has a function for managing a web site for delivering the ringing tone melodies and its web pages. In this, the server for delivering ringing tone melodies 20 is also able to have the web site for delivering ringing tone melodies inside the server.

As shown in FIG. 1, the server for delivering ringing tone melodies 20 provides a user terminal management database 21 (judging information storing means), a sound data management database 22 (sound data storing means), and a delivered information management database 23 (delivered information storing means).

In this, these databases 21, 22, and 23 can be also provided outside the server for delivering ringing tone melodies 20, instead of providing inside the server for delivering ringing tone melodies 20. In this case, these databases 21, 22, and 23 are connected to the server for delivering ringing tone melodies 20.

The user terminal management database 21 stores information of the remaining number of ringing tone melodies, which can be delivered to each of the user terminals 30a and 30b in the future, after delivered some of the ringing tone melodies. The sound data management database 22 stores sound data of the ringing tone melodies to be delivered to the user terminals 30a and 30b. The delivered information management database 23 stores information of the delivered accumulation number of the ringing tone melodies in each title.

Each of the user terminals 30a and 30b is, for example, a mobile communication terminal, and is managed by the user of each mobile communication terminal. Each of the user terminals 30a and 30b provides hardware and software for transmitting information to the network 40 and receiving information from the network 40 by connecting to the network 40 such as the Internet.

In this, as mentioned above, each of the user terminals is the mobile communication terminal, however, the user terminal is not limited to the mobile communication terminal. That is, any unit, which can be connected to the network 40 and can reproduce the sound data, such as a telephone connecting to a wire channel, can be used as the user terminal. Or a PC (personal computer) that utilizes the Internet telephony and receives a phone call, or some PDA (personal digital assistants) that can receive an e-mail, can be the user terminal.

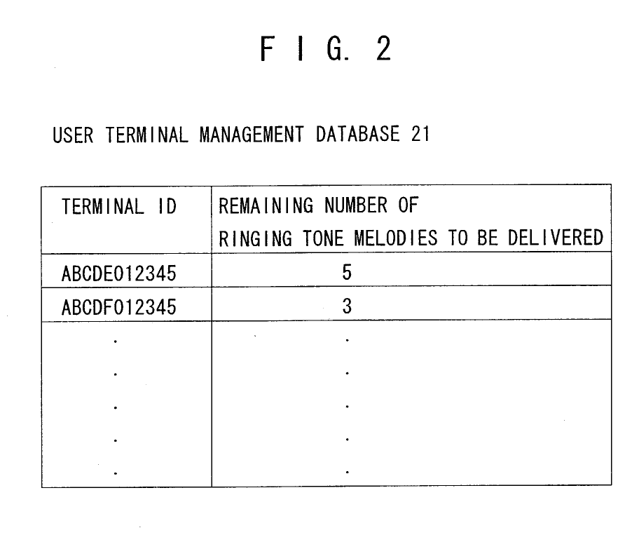

FIG. 2 is a diagram showing an example of a data storing state in the user terminal management database 21 at a first embodiment of the present invention. As shown in FIG. 2, at the first embodiment of the present invention, judging information, whether a ringing tone melody can be delivered to a user terminal or not, is stored in the user terminal management database 21. Actually, the terminal ID (identification) allocated to each of the user terminals 30a and 30b, and the remaining number of ringing tone melodies, which can be delivered to each of the user terminals 30a and 30b in the future, after delivered some of the ringing tone melodies, are stored in the user terminal management database 21. As shown in FIG. 2, each of the terminal IDs and the remaining number of the ringing tone melodies to be delivered to the corresponding terminal ID are stored in the user terminal management database 21. That is, 5 ringing tone melodies can be delivered to a user terminal having the terminal ID “ABCDE012345” in the future, and 3 ringing tone melodies can be delivered to a user terminal having the terminal ID “ABCDF012345” in the future.

A company that manages the server for delivering ringing tone melodies 20 registers the terminal ID of each of the user terminals 30a and 30b and the number of ringing tone melodies, which can be delivered to each of the user terminals 30a and 30b, in the user terminal management database 21, before the user terminals 30a and 30b are on the shelf of a store. In this, the number of ringing tone melodies, which can be delivered to each of the user terminals 30a and 30b, is the predetermined number and the maximum number of the ringing tone melodies to be delivered to each of the user terminals 30a and 30b, and is the initial value of the remaining number of ringing tone melodies to be delivered to each of the user terminals 30a and 30b.

For example, it is assumed that there exists a user terminal, to which 5 ringing tone melodies are allowed to register (the maximum number is 5). In this case, the terminal ID of the user terminal and the corresponding number “5”, which is the maximum number of ringing tone melodies to be delivered to the user terminal, are stored in the user terminal management database 21. The company that manages the server for delivering ringing tone melodies 20, for example, obtains the terminal ID and the maximum number of the ringing tone melodies to be delivered to each of the user terminals 30a and 30b from their manufacturers, and registers them in the user terminal management database 21. This is a method to register the terminal IDs and the remaining number of ringing tone melodies corresponding to each of the terminal IDs.

As another method, the following method is also possible. The terminal ID and the maximum number of ringing tone melodies to be delivered to each of the user terminals are registered to the user terminal management database 21 by each of the manufacturers of the user terminals by using their PCs via the network 40.

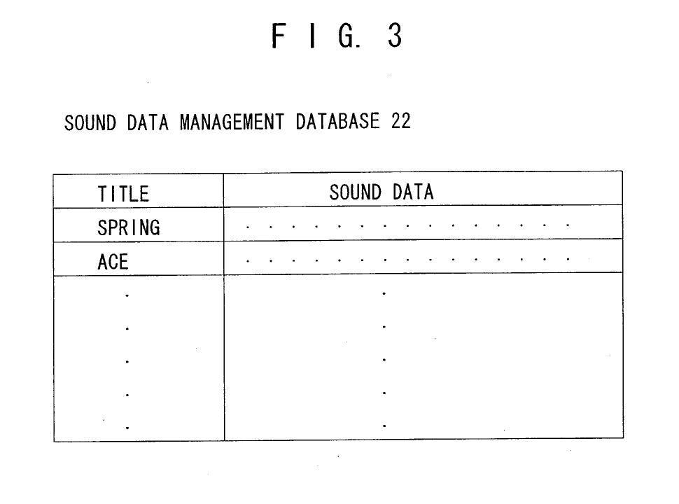

FIG. 3 is a diagram showing an example of a data storing state in the sound data management database 22 at the embodiments of the present invention. As shown in FIG. 3, the information of plural ringing tone melodies to be delivered to the user terminals 30a and 30b has been stored in the sound data management database 22 by the company that manages the server for delivering ringing tone melodies 20. That is, the title of each of the ringing tone melodies and the sound data corresponding to the title have been stored in the sound data management database 22. The sound data are, for example, data conforming to the MIDI (musical instrument digital interface) standard, and are sound source data generating a melody when the sound data are reproduced at the user terminals 30a and 30b.

Each of the ringing tone melodies storing in the sound data management database 22 is a melody that needs to pay a royalty to a copyright holder when the melody is used. Further, information, relating to the melody, such as a composer, an arranger, a song writer, a singer, a band, and a released date, can be stored in the sound data management database 22.

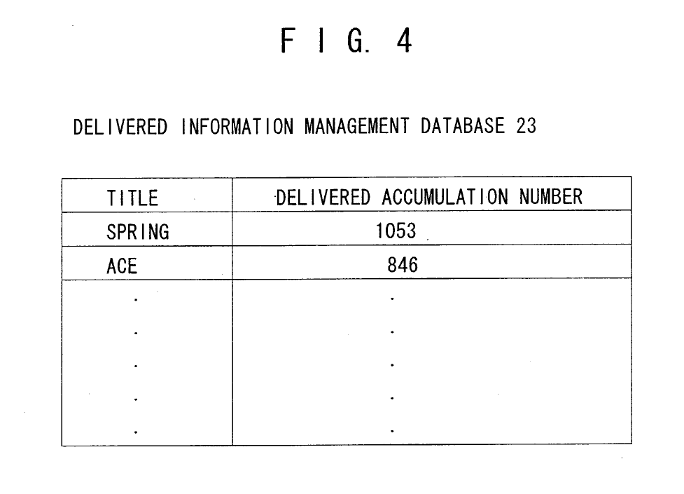

FIG. 4 is a diagram showing an example of a data storing state in the delivered information management database 23 at the embodiments of the present invention. In the delivered information management database 23, data signifying the delivered accumulation number of each of the ringing tone melodies are stored. That is, the title of each of the ringing tone melodies and the delivered accumulation number of each of the ringing tone melodies corresponding to the title are stored in the delivered information management database 23. In FIG. 4, the delivered accumulation number of a melody having the title “SPRING” is 1053, and the delivered accumulation number of a melody having its title “ACE” is 846.

In this, it is desirable that the delivered accumulation number is obtained in each of payers who pay the royalties to the copyright holders. Therefore, for example, it is possible that the delivered information management database 23 is provided for each of the manufacturers of the user terminals. At this example, it is assumed that the royalty paying to a copyright holder per ringing tone melody is decided as a uniform value, for example, ¥5.5/melody.

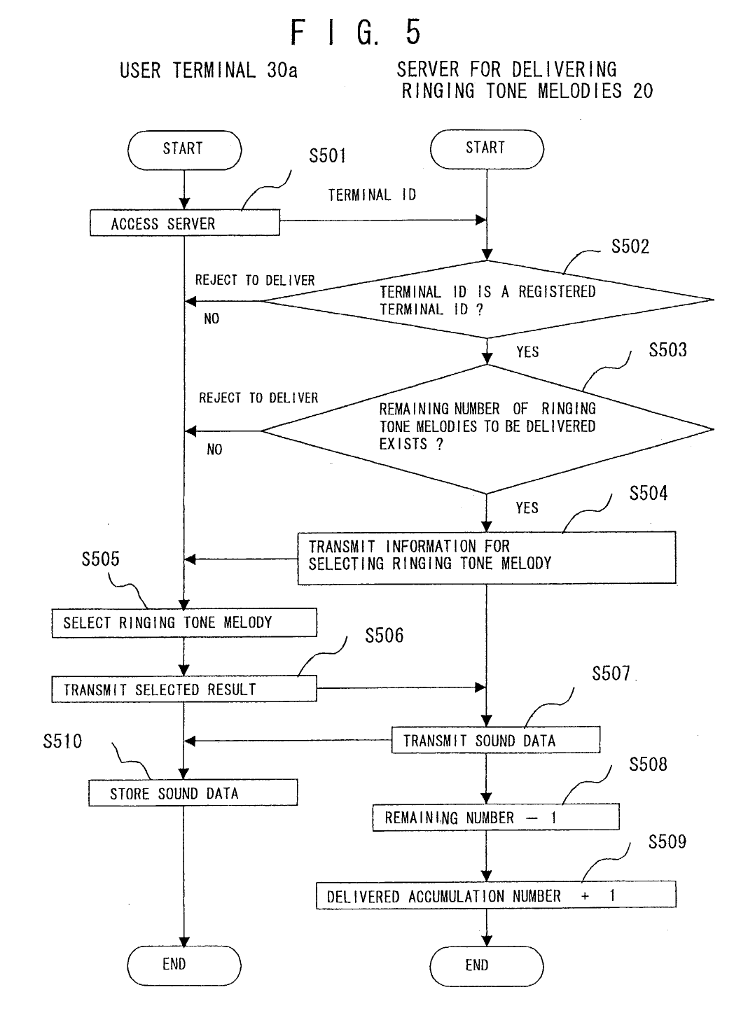

Next, referring to the drawings, the operation of the system for delivering sound data 10 is explained. That is, a method for delivering sound data at the first embodiment of the present invention is explained. FIG. 5 is a flowchart showing ringing tone melody delivering processes and their process timing at the system for delivering sound data 10 at the first embodiment of the present invention.

In this operation, a case, in which the server for delivering ringing tone melodies 20 delivers a ringing tone melody to the user terminal 30a that was purchased by a user A by the request from the user terminal 30a, is explained. In this case, it is assumed that any ringing tone melodies that need to pay royalties to copyright holders are not included in the built-in ringing tone melodies when the user A purchased the user terminal 30a. Further, it is assumed that the number of the ringing tone melodies, which have not been built in the user terminal 30a and can be obtained by the user A freely after the user A purchased the user terminal 30a, is decided to be 5.

Therefore, in this case, the user A can decide to purchase the user terminal 30a, by confirming that the user A can obtain 5 ringing tone melodies by selecting freely after its purchase.

First, the user terminal 30a accesses the server for delivering ringing tone melodies 20 (a ringing tone melody delivering web site) via the network 40, based on the operation of the user A (step S501). In this, the ringing tone melody delivering web site is connected to the server for delivering ringing tone melodies 20, or can be included in the server for delivering ringing tone melodies 20.

In this example, the URL (uniform resource locator) of the ringing tone melody delivering web site has been registered in the user terminal 30a. And a selection region to select a process for accessing the ringing tone melody delivering web site is provided in a selection menu, in which several functions to be selected are provided, displaying on a display (for example, liquid crystal display) of the user terminal 30a. Therefore, the user A can access the ringing tone delivering web site, by only selecting the selection region.

When the server for delivering ringing tone melodies 20 received the access to the ringing tone melody delivering web site from the user terminal 30a, the server for delivering ringing tone melodies 20 requests the user terminal 30a to transmit the terminal ID of the user terminal 30a, when the terminal ID has not been transmitted. The user terminal 30a transmits its own terminal ID to the server for delivering ringing tone melodies 20, when the user terminal 30a received the request of transmitting the terminal ID from the server for delivering ringing tone melodies 20. In this, when the request of transmitting the terminal ID was received, the user terminal 30a displays a confirming screen on the display, and only in case that the user A permitted to transmit the terminal ID on the confirming screen, the terminal ID is transmitted to the server for delivering ringing tone melodies 20. This method is possible. For example, “Do you transmit your terminal ID ?” is displayed on the confirming screen, and when “Yes” on the display is selected by a button operation of the user A, the terminal ID is transmitted to the server for delivering ringing tone melodies 20.

Next, the server for delivering ringing tone melodies 20 confirms whether the terminal ID transmitted from the user terminal 30a is one of the terminal IDs having been registered in the user terminal management database 21 or not, when the terminal ID was received (step S502). In case that the terminal ID transmitted from the user terminal 30a is not one of the terminal IDs having been registered in the user terminal management database 21 (NO at the step S502), the server for delivering ringing tone melodies 20 informs the user terminal 30a about the rejection of delivering the ringing tone melody.

In case that the terminal ID transmitted from the user terminal 30a is one of the terminal IDs having been registered in the user terminal management database 21 (YES at the step S502), the server for delivering ringing tone melodies 20 confirms whether the remaining number of ringing tone melodies to be delivered corresponding to the terminal ID in the user terminal management database 21 is “0” or not (exists) (step S503). When the remaining number of ringing tone melodies to be delivered is “0” (NO at the step S503), that is, this signifies that delivering ringing tone melodies to the user terminal 30a from the server for delivering ringing tone melodies 20 has already completed, therefore, the server for delivering ringing tone melodies 20 informs the user terminal 30a about the rejection of delivering ringing tone melody.

When the remaining number of ringing tone melodies to be delivered is not “0” (exists) (YES at the step S503), that is, this signifies that delivering ringing tone melodies to the user terminal 30a from the server for delivering ringing tone melodies 20 has not completed yet. Therefore, the server for delivering ringing tone melodies 20 transmits information, which requests the user terminal 30a to select a ringing tone melody, to the user terminal 30a (step S504). In the information for selecting a ringing tone melody transmitted from the server for delivering ringing tone melodies 20, information of contents showing the list of titles of ringing tone melodies, storing in the sound data management database 22, is included.

When the user terminal 30a received the information for selecting a ringing tone melody, the user terminal 30a displays the list of the titles of the ringing tone melodies, based on the information of the contents, on its display. The user A decides a ringing tone melody, which the user A desires to obtain, by confirming each of the titles on the display. And the user A selects the decided title of the ringing tone melody by operating an input unit (for example, operating buttons) of the user terminal 30a (step S505). When the title of the ringing tone melody is selected by the user A, the user terminal 30a transmits information of the selected result showing the selected title to the server for delivering ringing tone melodies 20 (step S506).

When the information of the selected result was received, the server for delivering ringing tone melodies 20 reads the sound data of the ringing tone melody, shown by the title of the information of the selected result, from the sound data management database 22. And the server for delivering ringing tone melodies 20 transmits the sound data of the ringing tone melody of the title to the user terminal 30a via the network 40, without a charge (step S507).

After the sound data of the ringing tone melody of the title, which was selected by the user A, was transmitted to the user terminal 30a, the server for delivering ringing tone melodies 20 subtracts “1” from the remaining number of ringing tone melodies to be delivered, corresponding to the terminal ID of the user terminal 30a, storing in the user terminal management database 21 (step S508). Further, the server for delivering ringing tone melodies 20 adds “1” to the delivered accumulation number, corresponding to the title of the ringing tone melody transmitted to the user terminal 30a, storing in the delivered information management database 23 (step S509). In this case, the addition of the delivered accumulation number is carried out in each of the delivered information management database 23, which has been provided for each of the manufacturers of user terminals that are specified by the terminal IDs.

When the sound data of the ringing tone melody of the title, which was selected by the user A, was received, the user terminal 30a stores the received ringing tone melody of the title in a ringing tone melody setting region in a recording media of the user terminal 30a (step S510). After this, in case that the user set the received ringing tone melody as its own ringing tone melody, when a phone call is received by the user terminal 30a, the melody of the set ringing tone melody, which was delivered from the server for delivering ringing tone melodies 20, is generated.

At the embodiments of the present invention, the server for delivering ringing tone melodies 20 calculates the royalties to pay copyright holders every certain period (for example, every day, every week, or every month), based on the title and the delivered accumulation number storing in the delivered information management database 23. For example, it is assumed that the delivered accumulation number of ringing tone melodies of a title is 1000, storing in the delivered information management database 23 provided for a manufacturer. And also it is assumed that the royalty for the copyright holder, which is charged by delivering the sound data per once, is ¥5.5. In this case, the royalties to pay the copyright holder for the ringing tone melody of the title from the manufacturer are ¥5500.

It is possible that the company managing the server for delivering ringing tone melodies 20 pays the royalties from the deposits from each of the manufacturers of the user terminals. In this case, the royalties for each manufacturer are calculated based on the information storing in the delivered information management database 23. And the royalties are paid to organizations, such as JASRAC (Japanese Society for Right of Authors, Composers and Publishers) that receives the royalties, from the deposits from respective manufacturers, based on the calculated results. This payment method is possible. The payment of the royalties can be done by any methods. For example, each manufacturer pays the royalties independently based on the information transmitted from the delivered information management database 23.

As mentioned above, according to the first embodiment of the present invention, it is judged whether a request to obtain a ringing tone melody is a request from a user terminal that can obtain the ringing tone melody as its own ringing tone melody or not. Further it is judged whether the user terminal has completed to obtain all the number of the ringing tone melodies that the user terminal can obtain or not. And the ringing tone melodies are delivered to the user terminal based on these judged results. Furthermore, after a user purchased a user terminal, ringing tone melodies, which the user desires to register, are delivered to the user terminal, therefore, the user can register his/her desiring ringing tone melodies as his/her own ringing tone melodies in his/her user terminal. Consequently, it can be avoided that the user is obliged to pay the royalties of unwanted ringing tone melodies, and the payment burden for the user can be lessened. That is, the user can select his/her own ringing tone melodies freely after the user purchased the user terminal, and the user only bears the royalties for the predetermined number of the ringing tone melodies. Therefore, the price of the user terminal for the user becomes reasonable.

Moreover, according to the first embodiment of the present invention, the sound data management database 22 stores a large number of sound data, and the user can select plural (for example, 5) ringing tone melodies from the sound data management database 22. Therefore, it can be avoided that the user obtains his/her desiring ringing tone melody from another web site that delivers ringing tone melodies with a charge.

Furthermore, according to the first embodiment of the present invention, the ringing tone melodies are delivered after the user purchased the user terminal, therefore, the user can register a ringing tone melody, which was released after the user had purchased the user terminal, in his/her user terminal. Therefore, a latest melody, which was released soon after the user had purchased the user terminal, can be registered in the user terminal as its own ringing tone melody.

At the first embodiment of the present invention mentioned above, as a ringing tone, which is a sound that is generated at the time when a user terminal received a phone call or an e-mail, a ringing tone melody that signifies music is used as sound data. However, a ringing tone voice, which is not music but a voice of a person or an animal, can be used as the sound data for the ringing tone. That is, the user can set the ringing tone voice as his/her own ringing tone after the user purchased the user terminal. In this case, the ringing tone voices are also stored in the sound data management database 22. Further, a song can be made to a ringing tone, in this case, songs are stored in the sound data management database 22.

Furthermore, at the first embodiment of the present invention mentioned above, as the user terminal, a mobile communication terminal is used, however, the user terminal is not limited to the mobile communication terminal. That is, any unit, which can be connected to the network 40 and can reproduce the sound data, such as a telephone connecting to a wire channel, can be used as the user terminal. Or a PC that utilizes the Internet telephony and receives a phone call, or some PDA (personal digital assistants) that can receive an e-mail, can be the user terminal.

At the first embodiment of the present invention mentioned above, a user terminal is identified by its terminal ID. However, for example, a user ID and a password for a user terminal, for using the system for delivering sound data 10, are set before the user terminal is sold, and the user terminal is identified by using the user ID and the password, this identification method is also possible. Or a user terminal can be identified by using an ID named a subscriber ID made by its telephone number. When the telephone number is changed, the subscriber ID is also changed, however, in this case, the user requests to change the information storing in the user terminal management database 21 by informing the subscriber ID before changed and the changed subscriber ID. And the company managing the server for delivering ringing tone melodies 20 changes the information storing in the user terminal management database 21.

At the first embodiment of the present invention mentioned above, a user terminal is identified by its terminal ID. However, a user ID and a password for a user not for a user terminal, for using the system for delivering sound data 10, are set before the user terminal is sold, and the user is identified by using the user ID and the password, this identification method is also possible. In this case, the user is identified by the user ID and the password, therefore, in case that the user has plural user terminals, the user can set the ringing tone melodies to the plural user terminals by allocating the plural ringing tone melodies to each of the user terminals.

Next, a second embodiment of the present invention is explained. At the first embodiment of the present invention mentioned above, delivering a ringing tone melody is judged by using the remaining number of the ringing tone melodies to be delivered. However, at the second embodiment of the present invention, instead of using the remaining number of ringing tone melodies, delivering the ringing tone melody is judged by using the remaining amount of royalties to be paid to the copyright holders.

At the second embodiment of the present invention, the maximum amount of the royalties to be paid to the copyright holders is set as the initial value, for example, ¥27.5 for each user terminal, and when a ringing tone melody was delivered to a user terminal, the amount of the royalty of the delivered ringing tone melody is subtracted from the initial value. And in case that the user requests to deliver a new ringing tone melody, when the amount of the royalty for the new ringing tone melody does not exceed the current remaining amount of the royalties, the new ringing tone melody is delivered to the user terminal. In this case, even when the royalty per melody to be paid to each of the copyright holders is not decided uniformly, the ringing tone melodies can be delivered to the user terminal based on the amount of the royalties bearing by the user. In this case, first, a ringing tone melody, which the user desires to obtain, is selected, and the selected result is transmitted to the server for delivering ringing tone melodies 20, and after this, the remaining amount of the royalties is confirmed.

At the second embodiment of the present invention, the user terminal management database 21 stores the terminal IDs and the remaining amount of royalties corresponding to each of the terminal IDs, instead of the remaining number of ringing tone melodies at the first embodiment.

Further, at the flowchart shown in FIG. 5, the order of the processes is different from at the first embodiment, in case that the royalty per one melody is different among melodies. At the first embodiment of the present invention mentioned above, after the terminal ID and the remaining number of the ringing tone melodies to be delivered were confirmed (the steps S502 and S503), a ringing tone melody, which is desired by the user, is selected (the step S505). However, at the second embodiment, first, a ringing tone melody desired by the user is selected, and after the selected result was transmitted from the user terminal to the sever for delivering ringing tone melodies 20, the terminal ID and the remaining amount of royalties are confirmed. This method is possible at the second embodiment.

At the first embodiment of the present invention mentioned above, in a case that the received terminal ID is not in the registered terminal IDs, or the remaining number of the ringing tone melodies to be delivered is “0”, delivering the ringing tone melody is rejected. However, at the second embodiment, it is possible that the ringing tone melody is delivered to the user terminal by charging the amount of royalties to the user terminal.

At the first embodiment of the present invention, the server for delivering ringing tone melodies 20 is operated by a control program (computer program for delivering sound data) for making the processes mentioned above work. This control program is a computer program, which makes sound data storing in the sound data management database 22 deliver to, for example, the user terminals 30a via the network 40, and the following steps are included in the control program. A first step is that the server for delivering ringing tone melodies 20 receives a request, which the user terminal 30a desires to obtain sound data, from the user terminal 30a via the network 40. A second step is that the server for delivering ringing tone melodies 20 judges whether the sound data is delivered to the user terminal 30a or not, based on the information of the remaining number of the ringing tone melodies to be delivered, after the request was received. A third step is that the server for delivering ringing tone melodies 20 delivers the sound data to the user terminal 30a via the network 40 within the range of the remaining number of the ringing tone melodies to be delivered without a charge, when the judgement was to deliver. A fourth step is that the server for delivering ringing tone melodies 20 subtracts “1” from the remaining number of ringing tone melodies to be delivered, storing in the user terminal management database 21, after the ringing tone melody was delivered. And a fifth step is that the server for delivering ringing tone melodies 20 adds “1” to the delivered accumulation number, storing in the delivered information management database 23.

At the second embodiment of the present invention, as the same as at the first embodiment, the server for delivering ringing tone melodies 20 is operated by a control program (computer program for delivering sound data) to make the processes mentioned above work. This control program is a computer program, which makes sound data storing in the sound data management database 22 deliver to, for example, the user terminals 30a via the network 40, and the following steps are included in the control program. A first step is that the server for delivering ringing tone melodies 20 receives a request, which the user terminal 30a desires to obtain sound data, from the user terminal 30a via the network 40. A second step is that the server for delivering ringing tone melodies 20 judges whether the sound data is delivered to the user terminal 30a or not, based on the information of the remaining amount of royalties, after the request was received. A third step is that the server for delivering ringing tone melodies 20 delivers the sound data to the user terminal 30a via the network 40 within the range of the remaining amount of the royalties without a charge, when the judgement was to deliver. A fourth step is that the server for delivering ringing tone melodies 20 subtracts the amount of royalty of the delivered ringing tone melody from the remaining amount of royalties, storing in the user terminal management database 21, after the ringing tone melody was delivered. And a fifth step is that the server for delivering ringing tone melodies 20 adds “1” to the delivered accumulation number, storing in the delivered information management database 23.

As mentioned above, according to the system for delivering sound data at the embodiments of the present invention, the system for delivering sound data provides plural user terminals, a server for delivering sound data (server for delivering ringing tone melodies), and a network. And the plural user terminals are connected to the server for delivering sound data via the network. The server for delivering sound data delivers sound data to each of the plural user terminals as its own sound data via the network. Each of the plural user terminals obtains the sound data from the server for delivering sound data via the network, and registers the received sound data as its own sound data.

The server for delivering sound data provides a judging information storing means (user terminal management database), a sound data storing means (sound data management database), and a delivered information storing means (delivered information management database). In the judging information storing means, the information of remaining quantity of sound data to be delivered to each of the plural user terminals in the future has been stored. That is, the remaining quantity of sound data is the remaining number of sound data or the remaining amount of royalties for sound data, which each of the plural user terminals can obtain in the future. In the sound data storing means, sound data, which are delivered to each of the plural user terminals as its own sound data, have been stored. And in the delivered information storing means, the delivered accumulation number of sound data in each of titles is stored.

In case that a user terminal requested the server for delivering sound data to deliver some sound data via the network, the server for delivering sound data delivers the sound data storing in the sound data storing means to the user terminal via the network within the range of the remaining quantity of the sound data, without a charge under the price condition of each of the plural user terminals. Therefore, the user terminal can freely select the sound data as its own sound data after the user purchased the user terminal, and the user bears only the royalties including in the price of the user terminal. Consequently, the payment burden for the user becomes reasonable. Further, the user can set a latest melody being sound data, which was released after the user had purchased the user terminal, as its own sound data.

According to the first embodiment of the present invention, the judging information storing means stores the terminal IDs of the plural user terminals and the information of the remaining number of sound data to be delivered to each of the terminal IDs. In this, each of the terminal IDs is used to identify each of the plural user terminals. As mentioned above, the remaining number of sound data is the number of sound data, which each of the plural user terminals can obtain in the future, and the server for delivering sound data can deliver the remaining number of sound data to each of the plural user terminals in the future. In this, initially, the maximum number of sound data, which the server for delivering sound data can deliver to each of the plural user terminals, is decided. And the remaining number is the number that the number of sound data delivered already is subtracted from the maximum number for each of the plural user terminals. In case that the server for delivering sound data received a request to deliver some sound data from a user terminal, the server for delivering sound data can deliver the sound data within the range of the remaining number of sound data corresponding to the terminal ID of the user terminal.

According to the second embodiment of the present invention, the judging information storing means stores the terminal IDs of the plural user terminals and the information of the remaining amount of royalties for each of the terminal IDs. In this, each of the terminal IDs is used to identify each of the plural user terminals. Initially, the maximum amount of royalties, which each of the plural user terminals can bear to pay for obtaining the sound data, is decided. And the remaining amount is the amount that the amount of royalties paid already for the delivered sound data is subtracted from the maximum amount for each of the plural user terminals. In case that the server for delivering sound data received a request to deliver some sound data from a user terminal, the server for delivering sound data can deliver the sound data within the range of the remaining amount corresponding to the terminal ID of the user terminal.

According to the embodiments of the present invention, in case that the user terminal is a mobile communication terminal having a radio communication function, the user of the mobile communication terminal can freely select its own sound data after the user purchased the mobile communication terminal, and the payment burden for the user of the mobile communication terminal can be made reasonable.

According to the embodiments of the present invention, in case that the sound data are sound source data of ringing tone melodies generating at the time when the user terminal received a phone call or an e-mail, the user can freely select a ringing tone melody as its own ringing tone melody, and the payment burden for the user of the user terminal can be made reasonable.

According to the embodiments of the present invention, in case that the sound data are sound source data of ringing tone voices generating at the time when the user terminal received a phone call or an e-mail, the user can freely select a ringing tone voice as its own ringing tone, and the payment burden for the user of the user terminal can be made reasonable.

According to the embodiments of the present invention, in the delivered information storing means, the delivered accumulation number of sound data in each of titles is stored. Therefore, the calculation of royalties to be paid to each of copyright holders in each of the titles can be made easy.

According to the embodiments of the server for delivering sound data of the present invention, the server for delivering sound data delivers sound data to each of plural user terminals as its own sound data via a network. The server for delivering sound data provides a judging information storing means, a sound data storing means, and a delivered information storing means. In the judging information storing means, the information of the remaining quantity of sound data to be delivered to each of the plural user terminals in the future has been stored. In the sound data storing means, sound data, which are delivered to each of the plural user terminals as its own sound data, have been stored. And in the delivered information storing means, the delivered accumulation number of sound data in each of titles is stored. In case that a user terminal requested the server for delivering sound data to deliver some sound data via the network, the server for delivering sound data delivers the sound data storing in the sound data storing means to the user terminal via the network within the range of the remaining quantity of the sound data, without a charge under the price condition of each of the plural user terminals. Therefore, the sound data can be delivered to the user terminal, which had been purchased, as its own sound data.

According to the embodiments of the server for delivering sound data of the present invention, the judging information storing means stores the terminal IDs to identify each of the plural user terminals, and the information of the remaining quantity of sound data for each of the terminal IDs. Therefore, a user terminal can be identified by its terminal ID, and it can be judged whether sound data are delivered to the user terminal as its own sound data or not, based on the information of the remaining quantity of sound data.

According to the first embodiment of the server for delivering sound data of the present invention, when some sound data were delivered to a user terminal based on the request from the user terminal, the number of delivered sound data is subtracted from the current remaining number of sound data, that is, the remaining number of sound data is renewed. Therefore, when a new request to deliver some sound data is generated, the judgement, whether the new request is accepted or not, can be made correctly, based on the renewed remaining number of sound data.

According to the second embodiment of the server for delivering sound data of the present invention, when some sound data were delivered to a user terminal based on the request from the user terminal, the amount of royalties of delivered sound data is subtracted from the current remaining amount of royalties, that is, the remaining amount of royalties is renewed. Therefore, when a new request to deliver some sound data is generated, the judgement, whether the new request is accepted or not, can be made correctly, based on the renewed amount of royalties.

According to the embodiments of the server for delivering sound data of the present invention, in the delivered information storing means, the delivered accumulation number of sound data in each of the titles is stored. Therefore, the calculation of royalties to be paid to copyright holders in each of the titles can be made easy.

As mentioned above, according to the first embodiment of the method for delivering sound data of the present invention, sound data are delivered to plural user terminals via a network as their own sound data from a server for delivering sound data. The server for delivering sound data receives a request to deliver some sound data from a user terminal. The server for delivering sound data judges whether the requested sound data are delivered or not, based on the information of the remaining number of sound data to be delivered to the user terminal, which signifies the number that the server for delivering sound data can deliver. When the request was accepted, the sound data are delivered to the user terminal within the range of the remaining number of sound data, without a charge under the price condition of each of the plural user terminals. Therefore, the sound data can be delivered to the user terminal, which has been purchased, as its own sound data.

As mentioned above, according to the second embodiment of the method for delivering sound data of the present invention, sound data are delivered to plural user terminals via a network as their own sound data from a server for delivering sound data. The server for delivering sound data receives a request to deliver some sound data from a user terminal. The server for delivering sound data judges whether the requested sound data are delivered or not, based on the information of the remaining amount of royalties for each of the plural user terminals. When the request was accepted, the sound data are delivered to the user terminal within the range of the remaining amount of royalties, without a charge under the price condition of each of the plural user terminals. Therefore, the sound data can be delivered to the user terminal, which has been purchased, as its own sound data.

As mentioned above, according to the first embodiment of the computer program for delivering sound data of the present invention, sound data are delivered to each of plural user terminals via a network as its own sound data from a server for delivering sound data. The computer program for delivering sound data provides the following several steps. A first step is a step that receives a request to deliver some sound data from a user terminal. A second step is a step that judges whether the requested sound data are delivered or not based on the information of the remaining number of sound data to be delivered to the user terminal, which signifies the number of sound data that can be delivered to the user terminal. A third step is a step that the sound data are delivered to the user terminal within the range of the remaining number of sound data, without a charge under the price condition of each of the plural user terminals, when the request was accepted. Therefore, the sound data can be delivered to the user terminal, which has been purchased, as its own sound data. Further, the computer program for delivering sound data provides the following steps. A fourth step is a step that the server for delivering sound data subtracts “1” from the remaining number of sound data to be delivered, storing in a judging information storing means, after the sound data were delivered. And a fifth step is a step that the server for delivering sound data adds “1” to the delivered accumulation number, storing in a delivered information storing means. Therefore, the calculation of royalties to be paid to copyright holders in each of the titles can be made easy.

As mentioned above, according to the second embodiment of the computer program for delivering sound data of the present invention, sound data are delivered to each of plural user terminals via a network as its own sound data from a server for delivering sound data. The computer program for delivering sound data provides the following several steps. A first step is a step that receives a request to deliver some sound data from a user terminal. A second step is a step that judges whether the requested sound data are delivered or not based on the information of the remaining amount of royalties for each of the plural user terminals, which signifies the amount of royalties for sound data. A third step is a step that the sound data are delivered to the user terminal within the range of the remaining amount of royalties, without a charge under the price condition of each of the plural user terminals, when the request was accepted. Therefore, the sound data can be delivered to the user terminal, which has been purchased, as its own sound data. Further, the computer program for delivering sound data provides the following steps. A fourth step is a step that the server for delivering sound data subtracts the amount of royalty of the delivered sound data from the remaining amount of royalties, storing in the judging information storing means, after the sound data were delivered. And a fifth step is a step that the server for delivering sound data adds “1” to the delivered accumulation number, storing in the delivered information storing means. Therefore, the calculation of royalties to be paid to copyright holders in each of the titles can be made easy.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A system for delivering sound data, which provides plural user terminals and a server for delivering sound data that delivers sound data to each of said plural user terminals via a network as sound data of each of said plural user terminals, and in which each of said plural user terminals obtains said sound data from said server for delivering sound data via said network and registers the obtained sound data as its own sound data, wherein:
said server for delivering sound data, comprising:
a judging information storing means, in which the information of remaining quantity of sound data to be delivered to each of said plural user terminals, showing the quantity of said sound data that each of said plural user terminals can obtain, is stored; and
a sound data storing means in which said sound data to be delivered to each of said plural user terminals are stored, wherein:
in case that each of said plural user terminals requests said server for delivering sound data to deliver some sound data via said network,
said server for delivering sound data delivers said sound data storing in said sound data storing means to each of said plural user terminals within the range of said information of remaining quantity of sound data to be delivered to each of said plural user terminals storing in said judging information storing means via said network, without a charge under the price condition of each of said plural user terminals.

2. A system for delivering sound data in accordance with claim 1, wherein:
said judging information storing means stores the terminal IDs of said plural user terminals for identifying each of said plural user terminals, and
said information of remaining quantity of sound data to be delivered to each of said plural user terminals is stored corresponding to each of said terminal IDs, and said information of remaining quantity of sound data is the information of remaining number of sound data to be delivered to each of said plural user terminals, and said remaining number of sound data is the number that the already delivered number of sound data to each of said plural user terminals is subtracted from the predetermined initial number of sound data that can be delivered to each of said plural user terminals, wherein:
in case that said server for delivering sound data receives a request to deliver some sound data from each of said plural user terminals,
said server for delivering sound data delivers said sound data storing in said sound data storing means to each of said plural user terminals within the range of said information of remaining number of sound data to be delivered to each of said plural user terminals storing in said judging information storing means via said network, without a charge under the price condition of each of said plural user terminals.

3. A system for delivering sound data in accordance with claim 1, wherein:
said judging information storing means stores the terminal IDs of said plural user terminals for identifying each of said plural user terminals, and
said information of remaining quantity of sound data to be delivered to each of said plural user terminals is stored corresponding to each of said terminal IDs, and said information of remaining quantity of sound data is the information of remaining amount of royalties for sound data to each of said plural user terminals, and said remaining amount of royalties is the amount that the amount of royalties for already delivered sound data to each of said plural user terminals is subtracted from the predetermined initial amount of royalties that each of said plural user terminals can use for obtaining said sound data, wherein:
in case that said server for delivering sound data receives a request to deliver some sound data from each of said plural user terminals,
said server for delivering sound data delivers said sound data storing in said sound data storing means to each of said plural user terminals within the range of said information of remaining amount of royalties for each of said plural user terminals storing in said judging information storing means via said network, without a charge under the price condition of each of said plural user terminals.

4. A system for delivering sound data in accordance with claim 1, wherein:
said server for delivering sound data, further comprising:
a delivered information storing means, in which the information of the delivered accumulation number of sound data in each title of said sound data is stored, wherein:
said server for delivering sound data accumulates the number of the delivered sound data in each title of said sound data and stores the delivered accumulation number in each title in said delivered information storing means, and
when royalties for each title of said sound data are paid to the copyright holder of each title, said information of said delivered accumulation number storing in said delivered information storing means is used.

5. A system for delivering sound data in accordance with claim 1, wherein:
each of said plural user terminals is a mobile communication terminal having a radio communication function.

6. A system for delivering sound data in accordance with claim 1, wherein:
each of said plural user terminals is a PC (personal computer) connecting to the Internet telephony or some PDA (personal digital assistants) that receives a phone call or an e-mail.

7. A system for delivering sound data in accordance with claim 1, wherein:
said sound data are sound source data of ringing tone melodies showing music that is used as a ringing tone at the time when each of said plural user terminals received a phone call or an e-mail.

8. A system for delivering sound data in accordance with claim 1, wherein:
said sound data are sound source data of ringing tone voices using as a ringing tone at the time when each of said plural user terminals received a phone call or an e-mail.

9. A server for delivering sound data, which delivers sound data to each of plural user terminals as its own sound data that is registered in each of said plural user terminals via a network, comprising:
a judging information storing means, in which the information of remaining quantity of sound data to be delivered to each of said plural user terminals, showing the quantity of said sound data that each of said plural user terminals can obtain, is stored; and
a sound data storing means in which said sound data to be delivered to each of said plural user terminals are stored, wherein:
in case that each of said plural user terminals requests said server for delivering sound data to deliver some sound data via said network,
said server for delivering sound data delivers said sound data storing in said sound data storing means to each of said plural user terminals within the range of said information of remaining quantity of sound data to be delivered to each of said plural user terminals storing in said judging information storing means via said network, without a charge under the price condition of each of said plural user terminals.

10. A server for delivering sound data in accordance with claim 9, wherein:
said judging information storing means stores the terminal IDs of said plural user terminals for identifying each of said plural user terminals, and
said information of remaining quantity to be delivered to each of said plural user terminals is stored corresponding to each of said terminal IDs.

11. A server for delivering sound data in accordance with claim 10, wherein:
said information of remaining quantity to be delivered to each of said plural user terminals is the information of remaining number of sound data to be delivered to each of said plural user terminals, being the information of the remaining number of sound data that each of said plural user terminals can obtain.

12. A server for delivering sound data in accordance with claim 11, wherein:
in case that said server for delivering sound data receives a request to deliver some sound data from each of said plural user terminals,
said server for delivering sound data delivers said sound data storing in said sound data storing means to each of said plural user terminals within the range of said information of remaining number of sound data to be delivered to each of said plural user terminals storing in said judging information storing means with each of said terminal IDs via said network, without a charge under the price condition of each of said plural user terminals.

13. A server for delivering sound data in accordance with claim 12, wherein:
in case that said server for delivering sound data delivered some sound data to each of said plural user terminals by receiving a request to deliver some sound data from each of said plural user terminals,
said server for delivering sound data renews said remaining number of sound data in said judging information storing means by subtracting the delivered number of sound data from said remaining number.

14. A server for delivering sound data in accordance with claim 10, wherein:
said information of remaining quantity to be delivered to each of said plural user terminals is the information of remaining amount of royalties for sound data to each of said plural user terminals, being the information of remaining amount of royalties for sound data that each of said plural user terminals can obtain some sound data by using said remaining amount of royalties.

15. A server for delivering sound data in accordance with claim 14, wherein:
in case that said server for delivering sound data receives a request to deliver some sound data from each of said plural user terminals,
said server for delivering sound data delivers said sound data storing in said sound data storing means to each of said plural user terminals within the range of said information of remaining amount of royalties for sound data to each of said plural user terminals storing in said judging information storing means with each of said terminal IDs via said network, without a charge under the price condition of each of said plural user terminals.

16. A server for delivering sound data in accordance with claim 15, wherein:
in case that said server for delivering sound data delivered some sound data to each of said plural user terminals by receiving a request to deliver some sound data from each of said plural user terminals,
said server for delivering sound data renews said remaining amount of royalties for sound data storing in said judging information storing means by subtracting the amount of royalties for the delivered sound data from said remaining amount.

17. A server for delivering sound data in accordance with claim 9, further comprising:
a delivered information storing means, in which the information of the delivered accumulation number of sound data in each title of said sound data is stored, wherein:
said server for delivering sound data accumulates the number of the delivered sound data in each title of said sound data and stores the delivered accumulation number in each title in said delivered information storing means, and
when royalties for each title of said sound data are paid to the copyright holder of each title, said information of said delivered accumulation number storing in said delivered information storing means is used.

18. A server for delivering sound data in accordance with claim 9, wherein:
said sound data are sound source data of ringing tone melodies showing music that is used as a ringing tone at the time when each of said plural user terminals received a phone call or an e-mail.

19. A server for delivering sound data in accordance with claim 9, wherein:
said sound data are sound source data of ringing tone voices using as a ringing tone at the time when each of said plural user terminals received a phone call or an e-mail.

20. A method for delivering sound data, in which sound data are delivered to each of plural user terminals via a network as its own sound data that is registered in each of said plural user terminals, comprising the steps of:
receiving a request for obtaining sound data from each of said plural user terminals via said network;
judging whether said sound data are delivered to each of said plural user terminals via said network or not, based on the information of remaining number of sound data to be delivered to each of said plural user terminals, when said request was received;
delivering said sound data to each of said plural user terminals within the range of said information of remaining number of sound data to be delivered without a charge under the price condition of each of said plural user terminals, when it was judged to deliver said sound data;
subtracting the delivered number of sound data from said remaining number of sound data in each of said plural user terminals; and
adding said delivered number of sound data to the delivered accumulation number of sound data in each title of said sound data.

21. A method for delivering sound data, in which sound data are delivered to each of plural user terminals via a network as its own sound data that is registered in each of said plural user terminals, comprising the steps of:
receiving a request for obtaining sound data from each of said plural user terminals via said network;
judging whether said sound data are delivered to each of said plural user terminals via said network or not, based on the information of remaining amount of royalties for sound data to be delivered to each of said plural user terminals, when said request was received;
delivering said sound data to each of said plural user terminals within the range of said information of remaining amount of royalties for sound data without a charge under the price condition of each of said plural user terminals, when it was judged to deliver said sound data;
subtracting the amount of royalties of the delivered sound data from said remaining amount of royalties in each of said plural user terminals; and
adding said delivered number of sound data to the delivered accumulation number of sound data in each title of said sound data.

22. A method for delivering sound data in accordance with claim 20, wherein:
said information of remaining number of sound data is stored corresponding to each of the terminal IDs of said plural user terminals.

23. A method for delivering sound data in accordance with claim 21, wherein:
said information of remaining amount of royalties for sound data is stored corresponding to each of the terminal IDs of said plural user terminals.

24. A computer program for delivering sound data, in which sound data are delivered to each of plural user terminals via a network as its own sound data that is registered in each of said plural user terminals, comprising:
a receiving step for receiving a request for obtaining sound data from each of said plural user terminals via said network;
a judging step for judging whether said sound data are delivered to each of said plural user terminals via said network or not, based on the information of remaining number of sound data to be delivered to each of said plural user terminals, when said request was received;
a delivering step for delivering said sound data to each of said plural user terminals within the range of said information of remaining number of sound data to be delivered without a charge under the price condition of each of said plural user terminals, when it was judged to deliver said sound data;
a subtracting step for subtracting the delivered number of sound data from said remaining number of sound data in each of said plural user terminals; and
an adding step for adding said delivered number of sound data to the delivered accumulation number of sound data in each title of said sound data.

25. A computer program for delivering sound data, in which sound data are delivered to each of plural user terminals via a network as its own sound data that is registered in each of said plural user terminals, comprising:
a receiving step for receiving a request for obtaining sound data from each of said plural user terminals via said network;
a judging step for judging whether said sound data are delivered to each of said plural user terminals via said network or not, based on the information of remaining amount of royalties for sound data to be delivered to each of said plural user terminals, when said request was received;
a delivering step for delivering said sound data to each of said plural user terminals within the range of said information of remaining amount of royalties for sound data without a charge under the price condition of each of said plural user terminals, when it was judged to deliver said sound data;
a subtracting step for subtracting the amount of royalties of the delivered sound data from said remaining amount of royalties in each of said plural user terminals; and
an adding step for adding said delivered number of sound data to the delivered accumulation number of sound data in each title of said sound data.

26. A computer program for delivering sound data in accordance with claim 24, wherein:
said information of remaining number of sound data is stored corresponding to each of the terminal IDs of said plural user terminals.

27. A computer program for delivering sound data in accordance with claim 25, wherein:
said information of remaining amount of royalties for sound data is stored corresponding to each of the terminal IDs of said plural user terminals.
